(19) United States
(12) Patent Application Publication
(10) Pub. No.: US 2006/0147044 A1
(43) Pub. Date: Jul. 6, 2006

(54) Copy-protected data carrier

(75) Inventors: Ralph Kurt, Eindhoven (NL); Robert Frans Maria Hendriks, Eindhoven (NL); Sepas Setayesh, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/551,325

(22) PCT Filed: Apr. 15, 2004
(86) PCT No.: PCT/IB04/01238

§ 371 Date: Oct. 18, 2005

(30) Foreign Application Priority Data
Apr. 23, 2003 (EP) 03290992.1

(51) Int. Cl. H04L 9/00

(52) U.S. Cl. 380/277

(57) ABSTRACT

The present invention relates to a data carrier comprising an information layer (1) itself comprising a specific area (4) able to deliver a first optical signal and a second optical signal when illuminated by a light source. Said data carrier also comprises an additional layer (2) able to deliver an electrical signal when illuminated by the second optical signal, said electrical signal corresponding to a predetermined pattern. The combination of the first optical signal and of the electrical signal forms a cryptographic key that is required to decrypt encrypted data contained in the information layer. This invention is particularly relevant to the read out of data stored on optical discs of the Read Only Memory type.

### FIELD OF THE INVENTION

The present invention relates to a data carrier.

The present invention also relates to a method of and a device for reading such a data carrier.

This invention is particularly relevant to the read out of data stored on optical discs, such as Small Factor Format Optical SFFO discs or Blu-ray discs, of the Read Only Memory ROM type or the like.

### BACKGROUND OF THE INVENTION

Up to now, it is relatively easy to make a copy identical to an original data carrier, and more especially to an original optical data carrier, simply by using replication techniques.

Counterfeit copying of such an optical data carrier has become a significant problem, resulting in less royalty income for license owners of a technology as well as for content distributors.

Several methods for preventing said copies have already been implemented For example, the international patent application WO 00/14734 discloses an optical data carrier containing primary data as well as security data in two separated layers. In this application, a beam of radiation is directed toward a data storage surface of the optical data carrier and reflected signals are converted into electrical signals. Said signals are processed to ascertain the presence of the primary data and the security data carried by the optical data carrier. Typically, an output is permitted to output the primary data only upon detection of appropriate security data.

According to this prior art, the read out of data is made optically, and the reflected optical signals are converted into electrical signals outside the optical data carrier. As a consequence, this solution is rather complex and expensive, as it needs a specific module for the conversion of an optical signal into an electrical signal. Moreover, said solution is not fully satisfactory as a hacker may have access to the security data and thus a counterfeit copy is still possible although such a copy may be difficult to achieve.

### SUMMARY OF THE INVENTION

It is an object of the invention to propose a data carrier that is less complex and more difficult to copy than the solution of the prior art.

To this end, the data carrier in accordance with the invention comprises an information layer comprising a specific area able to deliver a first optical signal and a second optical signal when illuminated by a light source, and a patterned additional layer able to deliver an electrical signal when illuminated by the second optical signal, said electrical signal corresponding to a predetermined pattern, the combination of the first optical signal and of the electrical signal forming a cryptographic key that is required to decrypt encrypted data contained in the information layer.

The present invention is based on the photoelectric or an equivalent effect. It is a hardware related solution, which is rather efficient to prevent illegal copying. As a matter of fact, the combination of the electrical signal and of the optical signal provides a complete cryptographic key that is required to get access to die data contained in the carrier. It is then very difficult for a hacker to copy the electrical signal onto an illegally replicated disc. And without said electrical signal, the cryptographic key can not be derived and, as a consequence, an illegally replicated disc containing only the optical signal can not be read out and is therefore useless. Moreover, a data carrier in accordance with the invention is both easy and cheap to manufacture.

According to an embodiment of the invention, the predetermined pattern is obtained from a segmentation of the additional layer in activated and deactivated areas. According to another embodiment, the additional layer comprises electrodes, one of which being segmented in order to obtain the predetermined pattern. According to another embodiment, the specific area is contained in the initialization area of the information layer. The additional layer may be a thermoelectric layer or a photoelectric layer. Said photoelectric layer can be made of amorphous silicon or of photoelectric tungsten disulfide.

The present invention also extends to a method of and device for reading such a data carrier. Said device for reading comprises means for reading the first optical signal delivered y the specific area of the information layer, means for reading the electrical signal delivered y the additional layer, means for computing a cryptographic key from a combination of the first optical signal and the electrical signal, and means for decrypting encrypted data contained in the data carrier from the cryptographic key.

The present invention also extends to a method of and device for recording information on such a data carrier. Said device for recording comprises means for reading the first optical signal delivered by the specific area of the information layer, means for reading he electrical signal delivered by the additional layer, means for computing a cryptographic key from a combination of the first optical signal and the electrical signal, means for encrypting information based on the cryptographic key, and means for storing the encrypted information on the data carrier.

These and other aspects of the present invention will be apparent from, and elucidated with reference to, the embodiment described herein.

### BRIEF DESCRIPTION OF THE DRAWINGS

The present invention will now be described in more detail, by way of example, with reference to the accompanying drawings, wherein:

FIG. 1 is a schematic perspective view of an embodiment of a data carrier in accordance with the invention,

FIG. 2 is a schematic view of a section of an embodiment of a data carrier in accordance with the invention,

FIG. 3 is a more detailed section view of the data carrier of FIG. 2 in accordance with the invention, and

FIG. 4 shows the chemical reaction illustrating a photo-oxidation of a polymer for manufacturing a data carrier in accordance with the invention.

### DETAILED DESCRIPTION OF THE INVENTION

The present invention is depicted in the following description in the case of an optical disc but it will be apparent to a person skilled in the art that the present invention is also applicable to other type of data carriers, such as, for example, magnetic disks.

The optical disc is, for example, of the ROM type. The invention is particularly useful in this case as it can prevent from mass copying the content of said ROM discs. However, it will be apparent to a person skilled in the art that the present invention stays applicable for other types of optical discs, for example of the rewritable RW type or of the write once R type, for which a user can decide to protect their personal data from being copied.

A conventional optical disc comprises a standard information layer comprising multimedia data such as text, audio or video. Such a conventional optical disc is not protected against illegal copying of said data. The present invention aims at proposing an easy and cheap solution for preventing this illegal copying.

To this end, said invention proposes to equip the new disc generation for optical data storage, such as Small Factor Format Optical SFFO discs or Blu-ray discs, with a patterned additional layer able to deliver an electrical signal when illuminated by an optical signal. Said additional layer is based on the photoelectric effect as described in the following description, or on the thermoelectric effect or any other suitable effect. In the case where the thermoelectric effect is utilized, the thermo-current generated by heat caused by irradiation of the light source is detected in the same manner as described below.

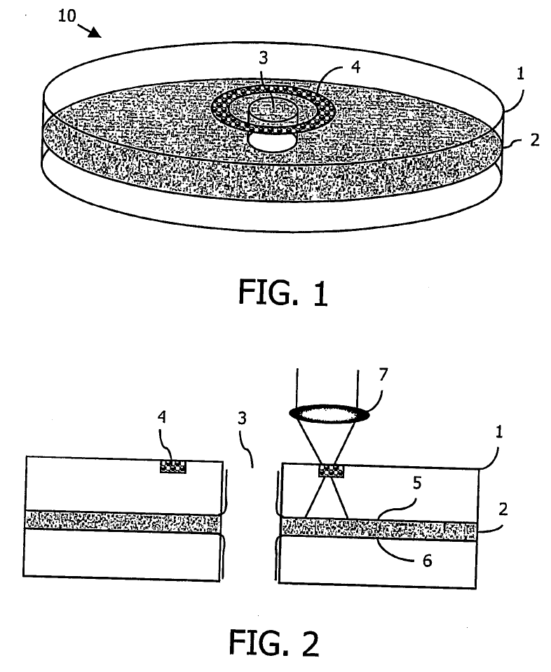

FIG. 1 gives a schematic perspective view of an embodiment of a data carrier in accordance with the invention.

The optical disc 10 comprises an information layer 1 able to deliver an optical signal. The optical signal is read out, for example from top, by an optical pick up unit OPU (not shown). In the present invention, the information layer comprises, for example, data content encrypted according to a predetermined cryptographic key.

It also comprises a photoelectric layer 2. This additional layer works on the basis of the photoelectric effect providing an electrical signal when illuminated by a light source such as a laser. The electrical signal is intended to be read out in a specific device in accordance with the invention, as described hereinafter. Said photoelectric layer can be an internal layer as shown on FIG. 1, or an external layer opposite to the information layer.

The rotation axis 3 of the disc corresponds to a hole in the disc. A specific area 4 of the information layer I is used for a modulation of the optical signal reaching the photoelectric layer 2. The specific area is, for example, the initialization area of the optical disc (i.e. the area of the disc that is read when the disc is inserted in the optical disc drive).

The modulated electrical signal combined with the optical signal taking into account their relative time behavior make the predetermined cryptographic key that gives access to the content of the optical disc.

It is relatively easy to read out this electrical signal together with the corresponding disc information But for a hacker, it is very difficult to copy this electrical signal onto another disc and a potential end-user of such a replicated disc needs this signal to read out the content of the disc. Moreover, reverse engineering is not possible, as it will destroy the information.

FIG. 2 gives a schematic view of a section of an embodiment of a data carrier in accordance with the invention.

An optical disc player must be able to read out the electrical signal 9 delivered by the photoelectric layer. For that purpose, some electrodes are required. The optical disc comprises an upper electrode 5, which needs to be transparent for the laser light. Said electrode is made of, for example, Indium Tin Oxide ITO films. Said disc also comprises a lower electrode 6, for example in Al, preferably coated with a low work function material such as LiF or CaF. The optical pick up unit OPU comprises here a laser 7 focused in the information layer.

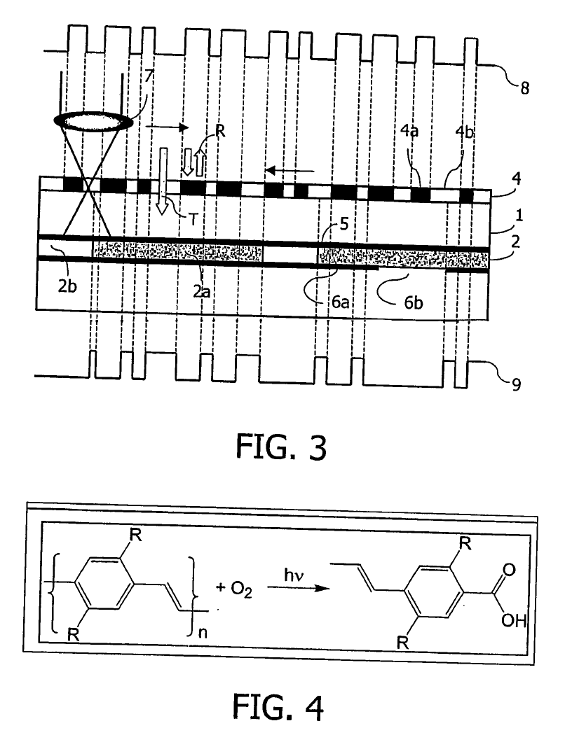

FIG. 3 describes in more detail an embodiment of the data carrier of FIG. 2.

Said optical disc comprises the specific area 4 of the information layer 1, for generating a reflected 4a and transmitted 4b optical signal, one of which being the reference optical signal 8. The form of said reference optical signal 8 depends on the structure of the specific area 4 of the information layer 1 as shown in FIG. 3. Said structure is adapted either to reflect R or to transmit T the light delivered by the light source.

The optical disc comprises the photoelectric layer 2 able to deliver the electrical signal 9 corresponding to a predetermined pattern, when illuminated by the signal from the information layer that does not form the optical signal.

According to a first embodiment of the invention, the photoelectric layer 2 is patterned using a segmental activating or deactivating of said layer. Thanks to this segmentation the electrical signal 9 corresponding to the predetermined pattern is generated when illuminated with an optical signal.

The predetermined pattern can be written in the photoelectric layer, for example during manufacturing of the disc by patterned UV irradiation in an oxygen environment. FIG. 4 shows the chemical reaction of that process, which is also called bleaching. Such a photo-oxidation of the polymer can locally destroy or deactivate the polymer. This results in a locally high-ohmic behavior, which does not give rise to any photocurrent under radiation.

Alternatively, the electrodes could also be patterned. For instance, thin metal films on silicon could be used, acting as metallic electrodes. After a local heating or after an irradiation, silicides are formed. Said silicides are typically defined by high-ohmic or semi-conducting behavior. Another way is to generate pinholes in either the upper or the lower electrode, for example using poly(3,4-éthylènedioxythiophène) PEDOT electrode which are easy to configure.

According to another embodiment, the two above-described embodiments can be combined, that it to say the photoelectric layer 2 is segmented in activated 2a and deactivated 2b areas and one electrode is segmented in segments 6a and 6b. FIG. 3 shows the electrical signal 9 resulting from such a combination.

In the example of FIG. 3, the reference optical signal 8 is the reflected signal 4a and the electrical signal 9 is obtained from the transmitted signal 4b. Nevertheless, it will be apparent to a person skilled in the art that it is also possible to read the reference optical signal in a transmission configuration, i.e. the reference optical signal 8 is the transmitted signal 4b, while detecting the photoelectric signal in reflection, i.e. the electrical signal 9 is obtained from the reflected signal 4a.

The photoelectric layer can be made of existing materials and stack combinations used in solar cells, for instance amorphous silicon as described by I. Garner in “Communications-International”, vol. 16, no. 3 (1989) 73.

It can also be made of photoelectric tungsten disulfide WS₂ as described in “Solar Energy Materials & Solar Cells”, by C. Balif, M. Regula, F. Levy, 57 (1999) 189, of copper, indium or gallium selenide, cadmium disulfide, cadmium diselenide, gallium arsenide, aluminum gallium arsenide.

The photoelectric layer can also be made of organic solar cell materials based on conjugated polymer. It can be, for example, conjugated polymer/methanofullerene as described in “2.5% Efficient Organic Plastic Solar Cells”, by S. E. Shaheen C. J. Brabec, N. S. Sariciftci, F. Padinger, T. Fromherz, J. C. Hummelen, Applied Physics Letters, vol. 78, no. 6 (2001) 841, or conjugated polymer/conjugated polymer, conjugated polymer/organic molecule, organic molecule/organic molecule, conjugated polymer/inorganic oxides, selenides and sulfides, organic molecule/inorganic oxides, selenides and sulfides.

The photoelectric layer can also be based on carbon nanotubes as described by E. Kymanskis et al. Applied Physics Letters, vol. 80, no. 1 (2002) 112, or nanowires, preferably carbon nanotubes or metal oxide nanotubes.

The efficiency of these materials used as solar cells is relatively low due to the broad solar spectrum. However the invention is related to future generation of optical storage, which will make use of relative short wavelength, such as 405 nm for blu-ray disk, where quantum efficiency of up to 60% can be reached using proper dye materials.

A conventional player for reading data carrier does not allow a read out of a data carrier in accordance with the invention as the data are encrypted on said carrier. That is why a device in accordance with the invention comprises:

means for reading the optical signal 8 delivered by the specific area 4 of the information layer 1,

means for reading the electrical signal 9 delivered by the additional layer 2,

means for computing a cryptographic key from a combination of the optical signal and the electrical signal, and

means for decrypting the encrypted data contained in the data carrier from the cryptographic key.

The means for computing are, for example, adapted to compute a correlation function of the optical and electrical signals, in order to obtain the cryptographic key.

It is to be noted that such a device is also able to read conventional discs, i.e. discs that are not encrypted. It means that a disc is read as a non-encrypted disc when no cryptographic key is detected.

It is also to be noted that the optical and electrical signals as well as the cryptographic key can be either digital or analog.

A device for reading such data carriers is consequently adapted to identify from the associated opto-electrical structure the characteristic information present on a data carrier, to derive from it the cryptographic key, and to decrypt the user-information recorded on the data carrier.

A recorder attempting to clone an original data carrier, i.e. to duplicate the user-information contained in an original data carrier, a ROM disc for example, on a second data carrier will not be able to record onto the second data carrier also the characteristic information, like the one present on the original data carrier, necessary to decrypt the user-information. As a consequence the user-information contained in the second data carrier cannot be decrypted and played.

However, the data carrier in accordance with the invention does not need to actually contain user-information, but it can also be a data carrier of recordable type, for example a RW or a R disc. A recorder for such a recordable data carrier will consequently be adapted to identify from the associated opto-electrical structure the characteristic information, to use said characteristic information to encrypt accordingly the user-information to be recorded, and to record the encrypted user-information.

Any reference sign in the following claims should not be construed as limiting the claim. It will be obvious that the use of the verb “to comprise” and its conjugations do not exclude the presence of any other steps or elements besides those defined in any claim. The word “a” or “an” preceding an element or step does not exclude the presence of a plurality of such elements or steps.

1. A data carrier (10) comprising:
an information layer (1) comprising a specific area (4) able to deliver a first optical signal (8) and a second optical signal when illuminated by a light source,
a patterned additional layer (2) able to deliver an electrical signal (9) when illuminated by the second optical signal, said electrical signal corresponding to a predetermined pattern,
the combination of the first optical signal (8) and of the electrical signal (9) forming a cryptographic key that is required to decrypt encrypted data contained in the information layer (1).

2. A data carrier as claimed in claim 1, wherein the predetermined pattern is obtained from a segmentation of the additional layer (2) in activated (2a) and deactivated (2b) areas.

3. A data carrier as claimed in claim 1, wherein the additional layer (2) comprises electrodes (5,6), one of which being segmented (6a,6b) in order to obtain the predetermined pattern.

4. A data carrier as claimed in claim 1, wherein the specific area (4) is contained in the initialization area of the information layer (1).

5. A data carrier as claimed in claim 1, wherein the additional layer (2) is a thermoelectric layer.

6. A data carrier as claimed in claim 1, wherein the additional layer (2) is a photoelectric layer.

7. A data carrier as claimed in claim 6, wherein the photoelectric layer (2) is made of amorphous silicon.

8. A data carrier as claimed in claim 6, wherein the photoelectric layer (2) is made of photoelectric tungsten disulfide.

9. A device for reading a data carrier as claimed in claim 1, said device comprising:
means for reading the first optical signal (8) delivered by the specific area (4) of the information layer (1),
means for reading the electrical signal (9) delivered by the additional layer (2),
means for computing a cryptographic key from a combination of the first optical signal (8) and the electrical signal (9), and
means for decrypting encrypted data contained in the data carrier from the cryptographic key.

10. A method of reading a data carrier as claimed in claim 1, said method comprising the steps of:
reading the first optical signal (8) delivered by the specific area (4) of the information layer (1),
reading the electrical signal (9) delivered by the additional layer (2),
computing a cryptographic key from a combination of the first optical signal (8) and the electrical signal (9), and
decrypting encrypted data contained in the data carrier from the cryptographic key.

11. A device for recording information on a data carrier as claimed in claim 1, said device comprising:
means for reading the first optical signal (8) delivered by the specific area (4) of the information layer (1),
means for reading the electrical signal (9) delivered by the additional layer (2),
means for computing a cryptographic key from a combination of the first optical signal (8) and the electrical signal (9),
means for encrypting information based on the cryptographic key, and
means for storing the encrypted information on the data carrier.

12. A method of recording information on a data carrier as claimed in claim 1, said method comprising the steps of:
reading the first optical signal (8) delivered by the specific area (4) of the information layer (1),
reading the electrical signal (9) delivered by the additional layer (2),
computing a cryptographic key from a combination of the first optical signal (8) and the electrical signal (9),
encrypting information based on the cryptographic key, and
storing the encrypted information on the data carrier.
